(19) United States
(12) Patent Application Publication
(10) Pub. No.: US 2023/0105107 A1
(43) Pub. Date: Apr. 6, 2023

(54) PLATE STRUCTURE FOR ARTICLE OF FOOTWEAR

(71) Applicant: NIKE, Inc., Beaverton, OR (US)

(72) Inventors: Sergio Cavaliere, Venezia (IT); Christian Steinbeck, Portland, OR (US); Kristin Yetman, Portland, OR (US)

(73) Assignee: NIKE, Inc., Beaverton, OR (US)

(21) Appl. No.: 17/936,223

(22) Filed: Sep. 28, 2022

Related U.S. Application Data
(60) Provisional application No. 63/251,572, filed on Oct. 1, 2021.

(51) Int. Cl. A43B 13/18; A43B 13/12; B29D 35/14

(52) U.S. Cl. CPC A43B 13/187; A43B 13/12; B29D 35/142

(57) ABSTRACT

A plate for an article of footwear includes a first barrier member and a second barrier member attached to the first barrier member to define an interior void between the first barrier member and the second barrier member. In addition, the plate includes a foam member disposed within and completely filling the interior void.

### CROSS REFERENCE TO RELATED APPLICATIONS

This application claims priority under 35 U.S.C. § 119(e) to U.S. Provisional Application No. 63/251,572, filed on Oct. 1, 2021. The disclosure of this prior application is considered part of the disclosure of this application and is hereby incorporated by reference in its entirety.

### FIELD

The present disclosure relates generally to an article of footwear and more particularly to a plate structure for an article of footwear.

### BACKGROUND

This section provides background information related to the present disclosure and is not necessarily prior art.

Articles of footwear conventionally include an upper and a sole structure. The upper may be formed from any suitable material(s) to receive, secure, and support a foot on the sole structure. The upper may cooperate with laces, straps, or other fasteners to adjust the fit of the upper around the foot. A bottom portion of the upper, proximate to a bottom surface of the foot, attaches to the sole structure.

Sole structures generally include a layered arrangement extending between a ground surface and the upper. For example, a sole structure may include a midsole and an outsole. The midsole is generally disposed between the outsole and the upper and provides cushioning for the foot. The outsole provides abrasion-resistance and traction with the ground surface and may be formed from rubber or other materials that impart durability and wear-resistance, as well as enhance traction with the ground surface.

While conventional sole structures adequately provide an article of footwear with cushioning and traction, such sole structures are often bulky due to the materials incorporated into the sole structure as well as the requisite amount of material needed to provide a desired stiffness, cushioning, and/or rigidity to the sole structure. As such, conventional sole structures may be designed and function well for a particular activity but adversely add to the overall weight of the article of footwear.

### DRAWINGS

The drawings described herein are for illustrative purposes only of selected configurations and not all possible implementations, and are not intended to limit the scope of the present disclosure.

FIG. 1 is a medial side perspective view of a plate structure for an article of footwear according to the present disclosure;

FIG. 2 is a top-front exploded perspective view of the plate structure of FIG. 1;

FIG. 3 is a cross-sectional view of the plate structure of FIG. 1, taken along Line 3-3 in FIG. 1;

FIG. 4 is an example process for producing the plate structure of FIG. 1;

FIG. 5 is an example process for producing the plate structure of FIG. 1;

FIGS. 6A-6D illustrate an example process of forming the plate structure of FIG. 1;

FIGS. 7A-7D illustrate an example process of forming a sole structure including the plate structure of FIG. 1;

FIG. 8 is a lateral side perspective view of an article of footwear incorporating a plate structure according to the present disclosure;

FIG. 9 is a top-front exploded perspective view of a plate structure according to the present disclosure;

FIG. 10 is a cross-sectional view of the plate structure of FIG. 9, taken across a width of the plate structure of FIG. 9 in a similar location as Line 3-3 of FIG. 1;

FIG. 11 is a top-front exploded perspective view of a plate structure according to the present disclosure; and

FIG. 12 is a cross-sectional view of the plate structure of FIG. 11, taken across a width of the plate structure of FIG. 11 in a similar location as Line 3-3 of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In one configuration, a plate for an article of footwear includes a first film member, a second film member attached to the first film member to define an interior void between the first film member and the second film member, and a foam member disposed within and completely filling the interior void.

The plate may include one or more of the following optional features. For example, at least one of the first film member and the second film member may be formed from thermoplastic polyurethane (TPU). Additionally or alternatively, the foam member may be formed from TPU. Further, at least two of the first film member, the second film member, and the foam member may be formed from the same material.

In one configuration, the first film member may be attached to a first side of the foam member and the second film member may be attached to a second side of the foam member, the second side being disposed on an opposite side of the foam member than the first side. A first adhesive may be disposed between the first film member and the first side of the foam member and a second adhesive may be disposed between the second film member and the second side of the foam member. At least one of the first adhesive and the second adhesive may be a hot melt adhesive.

At least one of the first film member and the second film member may define a rib. The foam member may extend into the rib within the interior void.

A sole structure for an article of footwear may incorporate the plate described above.

In another configuration, a plate for an article of footwear includes a first film member, a second film member attached to the first film member to define an interior void between the first film member and the second film member, and a foam member disposed within the interior void and being formed from the same material as at least one of the first film member and the second film member.

The plate may include one or more of the following optional features. For example, at least one of the first film member and the second film member may be formed from thermoplastic polyurethane (TPU). Additionally or alternatively, the foam member may be formed from TPU.

In one configuration, the first film member may be attached to a first side of the foam member and the second film member may be attached to a second side of the foam member, the second side being disposed on an opposite side of the foam member than the first side. A first adhesive may be disposed between the first film member and the first side of the foam member and a second adhesive may be disposed between the second film member and the second side of the foam member. At least one of the first adhesive and the second adhesive may be a hot melt adhesive.

In one configuration, at least one of the first film member and the second film member may define a rib. The foam member may extend into the rib within the interior void.

A sole structure for an article of footwear may incorporate the plate described above

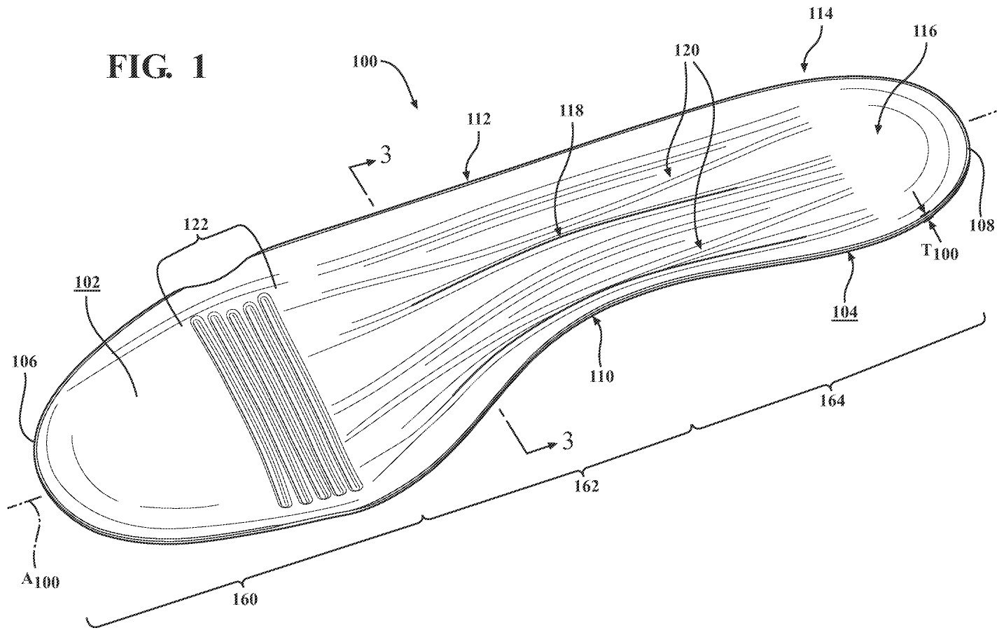

Referring to FIG. 1, a plate structure 100 includes an upper surface 102 and a lower surface 104 formed on an opposite side of the plate structure 100 than the upper surface 102. A thickness T₁₀₀ of the plate structure 100 is defined by the distance between the upper surface 102 and the lower surface 104. The plate structure 100 may further include an anterior end 106 associated with a forward-most point of the plate structure 100, and a posterior end 108 corresponding to a rearward-most point of the plate structure 100. A longitudinal axis A₁₀₀ of the plate structure 100 extends along a length of the plate structure 100 from the anterior end 106 to the posterior end 108 parallel to a ground surface, and generally divides the plate structure into a medial side 110 and a lateral side 112. Accordingly, the medial side 110 and the lateral side 112 respectively correspond with opposite sides of the plate structure 100, and extend from the anterior end 106 to the posterior end 108, while a lateral direction refers to the direction transverse to the longitudinal axis A₁₀₀ and extending from the medial side 110 to the lateral side 112.

The plate structure 100 may be divided into one or more regions. The regions may include a forefoot region 160, a mid-foot region 162, and a heel region 164. The forefoot region 160 may correspond with the phalanges and the metatarsal bones of the foot. The mid-foot region 162 may correspond with an arch area of the foot, and the heel region 164 may correspond with rear portions of the foot, including a calcaneus bone.

The plate structure 100 may be further described as including a peripheral region 114 and an interior region 116, as indicated in FIG. 1. The peripheral region 114 is generally described as being a region between the interior region 116 and an outer perimeter (i.e., edge) of the plate structure 100. Particularly, the peripheral region 114 extends from the forefoot region 160 to the heel region 164 along each of the medial side 110 and the lateral side 112, and wraps around each of the forefoot region 160 at the anterior end 106 and the heel region 24 at the posterior end 108. The interior region 116 is circumscribed by the peripheral region 114, and extends from the forefoot region 160, through the mid-foot region 162, to the heel region 164 along a central portion of the plate structure 100. Accordingly, each of the forefoot region 160, the mid-foot region 162, and the heel region 164 may be described as including the peripheral region 114 and the interior region 116.

The plate structure 100 is configured to provide lightweight support and may have a variable stiffness. The upper surface 102 includes a foot cavity that defines a footbed of the plate structure 100, while the lower surface 104 may define a portion of a ground-engaging surface. The plate structure 100 may be formed to include one or more ribs 118 extending along the longitudinal axis A₁₀₀ within the interior region 106 of the mid-foot region 162. The one or more ribs 118 may be recessed from the upper surface 102 of the plate structure 100 and correspond to projections in the lower surface 104 of the plate structure 100. The one or more ribs 118 may create a corresponding spine 120 disposed between the one or more ribs 118 that likewise extends along the longitudinal axis A₁₀₀ within the interior region 106 of the mid-foot region 162 along the central portion of the plate structure 100. As shown in FIG. 1, the spine 120 is a projection in the upper surface 102 of the plate structure 100 between the one or more ribs 118 and corresponds to a recess from the lower surface 104 of the plate structure 100. The one or more ribs 118 and corresponding spine 120 may provide increased stiffness and support in the plate structure 100.

The plate structure 100 may further be formed to include a plurality of grooves 122 to provide increased flexibility in the plate structure 100. The plurality of grooves 122 may be formed in the interior region 106 of the forefoot region 160 and extend in a direction transverse to the longitudinal axis A₁₀₀ between the medial side 110 and the lateral side 112. As shown, the plurality of grooves 122 are recessed from the upper surface 102 of the plate structure 100. While FIG. 1 shows the plurality of grooves 122 inset from the peripheral region 106 of the plate structure 100, the plurality of grooves 122 may extend fully between the medial side 110 (i.e., the medial edge) to the lateral side 112 (i.e., the lateral edge) of the peripheral region 106.

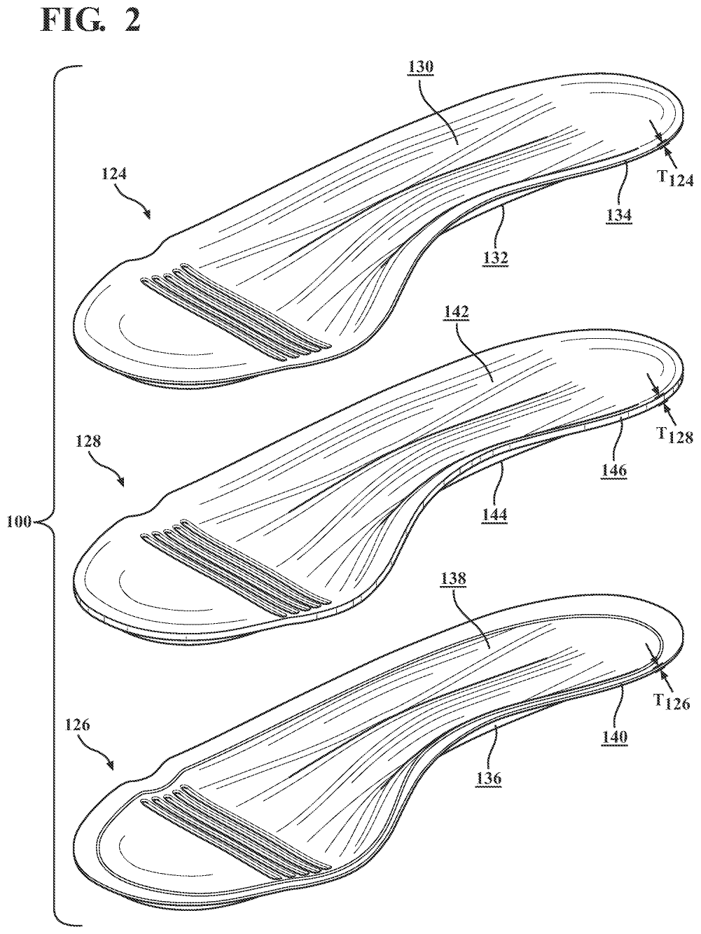

FIG. 2 provides an exploded view of the plate structure 100. Unlike conventional plate structures, which include monolithic materials, the plate structure 100 of the present disclosure is configured as a composite structure including a plurality of components joined together. For example, the plate structure 100 includes a first film member or barrier member 124, a second film member or barrier member 126, and a foam member 128 disposed between the first barrier member 124 and the second barrier member 126. By incorporating a foam member 128 including a foam cell structure between the barrier members 124, 128, the plate structure 100 may be significantly lighter than conventional plate structures that incorporate full density layers. The foam member 128 is a structural foam member having a higher rigidity than a form member conventionally used in a midsole. Accordingly, the foam member 128 provides the plate structure 100 with a degree of rigidity and strength.

The first barrier member 124, the second barrier member 126, and the foam member 128 may be formed from the same material to minimize manufacturing waste. Suitable materials may include thermoplastic polyurethane (TPU), polyamide (PA), polyethylene (PE), or polypropylene (PP). For example, the first barrier member 124, the second barrier member 126, and the foam member 128 may all be formed from TPU. Alternatively, at least one of the first barrier member 124 and the second barrier member 126 may be formed from a different material than the foam member 128. For example, at least one of the first barrier member 124 and the second barrier member 124 may be formed from PA, while the foam member 128 may be formed from TPU or PE. The foam member 128 may be formed from an open cell foam. Alternatively, the foam member 128 is formed from a closed cell foam. The foam member 128 may further provide thermal insulation properties to the plate structure 100 when the plate structure 100 is exposed to environments with extreme temperatures.

In other examples, the first barrier member 124, the second barrier member 126, and the foam member 128 are formed from different materials. In some examples, the first barrier element 124 may be formed from PA, the second barrier element 126 may be formed from TPU, while the foam member 128 may be formed from PP. As should be appreciated, any combination of TPU, PA, PE, and PP may be used. In examples where a different material is used for one or more of the first barrier member 124, the second barrier member 126, and the foam member 128, the plate structure 100 may be selectively contoured to accommodate material properties upon cooling.

Additionally, any of the first barrier member 124, the second barrier member 126, and the foam member 128 can be produced from a material that includes one or more thermoplastic polymers and/or one or more cross-linkable polymers. In an aspect, the material can include one or more thermoplastic materials, such as one or more thermoplastic polyurethane (TPU) copolymers, one or more ethylene-vinyl alcohol (EVOH) copolymers, and the like.

As used herein, “polyurethane” refers to a copolymer (including oligomers) that contains a urethane group (—N(C═O)O—). These polyurethanes can contain additional groups such as ester, ether, urea, allophanate, biuret, carbodiimide, oxazolidinyl, isocynaurate, uretdione, carbonate, and the like, in addition to urethane groups. In an aspect, one or more of the polyurethanes can be produced by polymerizing one or more isocyanates with one or more polyols to produce copolymer chains having (—N(C═O)O—) linkages.

Examples of suitable isocyanates for producing the polyurethane copolymer chains include diisocyanates, such as aromatic diisocyanates, aliphatic diisocyanates, and combinations thereof. Examples of suitable aromatic diisocyanates include toluene diisocyanate (TDI), TDI adducts with trimethyloylpropane (TMP), methylene diphenyl diisocyanate (MDI), xylene diisocyanate (XDI), tetramethylxylylene diisocyanate (TMXDI), hydrogenated xylene diisocyanate (HXDI), naphthalene 1,5-diisocyanate (NDI), 1,5-tetrahydronaphthalene diisocyanate, para-phenylene diisocyanate (PPDI), 3,3′-dimethyldiphenyl-4, 4′-diisocyanate (DDDI), 4,4′-dibenzyl diisocyanate (DBDI), 4-chloro-1,3-phenylene diisocyanate, and combinations thereof. In some configurations, the copolymer chains are substantially free of aromatic groups.

In particular aspects, the polyurethane polymer chains are produced from diisocynates including HMDI, TDI, MDI, H12 aliphatics, and combinations thereof. In an aspect, the thermoplastic TPU can include polyester-based TPU, polyether-based TPU, polycaprolactone-based TPU, polycarbonate-based TPU, polysiloxane-based TPU, or combinations thereof.

In another aspect, the polymeric layer can be formed of one or more of the following: EVOH copolymers, poly(vinyl chloride), polyvinylidene polymers and copolymers (e.g., polyvinylidene chloride), polyamides (e.g., amorphous polyamides), amide-based copolymers, acrylonitrile polymers (e.g., acrylonitrile-methyl acrylate copolymers), polyethylene terephthalate, polyether imides, polyacrylic imides, and other polymeric materials known to have relatively low gas transmission rates. Blends of these materials as well as with the TPU copolymers described herein and optionally including combinations of polyimides and crystalline polymers, are also suitable.

The first barrier member 124 is further defined by a top surface 130, a bottom surface 132 formed on an opposite side of the first barrier member 124 than the top surface 132, and a peripheral side surface 134 extending between the top surface 130 and the bottom surface 132 and defining an outer periphery of the first barrier member 124. A thickness T₁₂₄ of the first barrier member 124 is defined by the distance between the top surface 130 and the bottom surface 132.

The second barrier member 126 is further defined by a bottom surface 136 corresponding to the lower surface 104 of the plate structure 100, a top surface 138 formed on an opposite side of the second barrier member 126 than the bottom surface 136, and a peripheral side surface 140 extending between the bottom surface 136 and the top surface 138 and defining an outer periphery of the second barrier member 126. A thickness T₁₂₆ of the second barrier member 126 is defined by the distance between the bottom surface 136 and the top surface 138.

The foam member 128 is further defined by a top surface 142, a bottom surface 144 formed on an opposite side of the foam member 128 than the top surface 142, and a peripheral side surface 146 extending between the top surface 142 and the bottom surface 144 and defining an outer periphery of the foam member 128. A thickness T₁₂₈ of the foam member 128 is defined by the distance between the top surface 142 and the bottom surface 144.

The first barrier member 124 and the second barrier member 126 can have thicknesses T₁₂₄, T₁₂₆ ranging from about 0.2 millimeters to about 0.4 millimeters. The foam member 128 can have a thickness T₁₂₈ raging from about three millimeters to five millimeters. In further configurations, the thickness T₁₀₀ of the plate structure 100 has a maximum thickness of 3.5 millimeters. In some configurations, the thicknesses T₁₂₄, T₁₂₆ of the first barrier member 124 and the second barrier member 126 are different. In additional configurations, the thicknesses T₁₂₄, T₁₂₆, T₁₂₈ of the first barrier member 124, the second barrier member 126, and the foam member 128 are all different.

As discussed above with respect to FIG. 1, the material thicknesses selected for the plate structure 100 may result in a variable stiffness. Specifically, the stiffness of the plate structure 100 may be tuned based on the respective thicknesses T₁₂₄, T₁₂₆, T₁₂₈ of the first barrier member 124, the second barrier member 126, and the foam member 128. By forming the plate structure 100 of thicker materials, the thickness T₁₀₀ of the plate structure is increased, which results in a stiffer plate structure 100. Conversely, by forming the plate structure 100 of thinner materials, the thickness T₁₀₀ of the plate structure is decreased, which results in a more flexible plate structure 100.

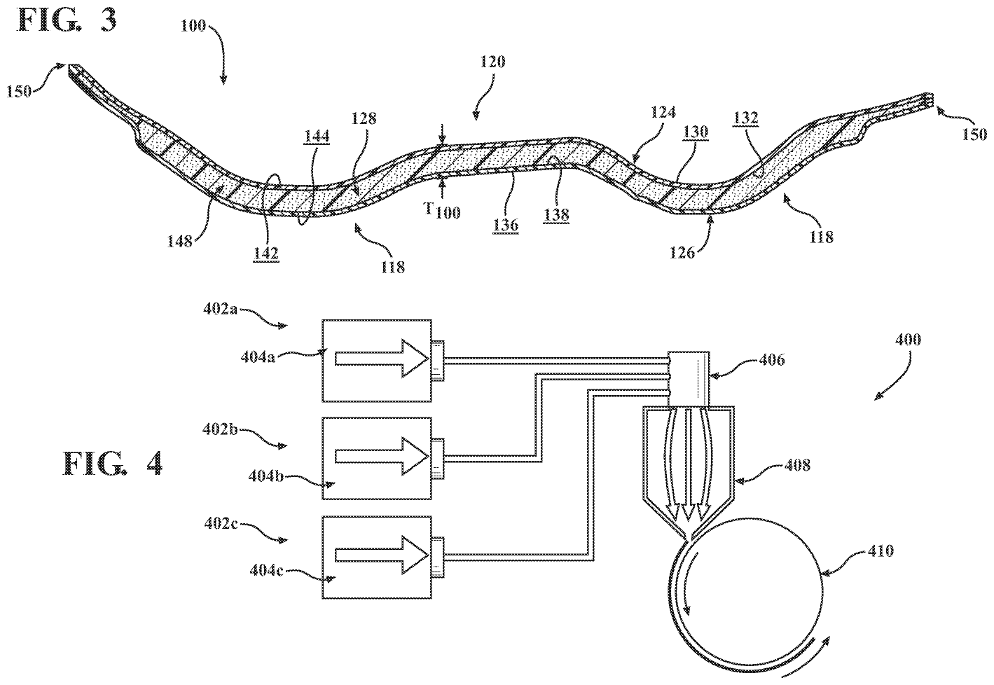

As shown in FIG. 3, the plate structure 100 includes the first barrier member 124 attached to the second barrier member 126 joined together at a peripheral edge 150 to define an interior void 148. The foam member 128 is disposed within and completely fills the interior void 148. As discussed with respect to FIG. 2, the first barrier member 124, the second barrier member 126, and the foam member 128 are arranged in a layered configuration. Accordingly, the bottom surface 132 of the first barrier member 124 opposes and is attached to the top surface 142 of the foam member 128. Likewise, the top surface 138 of the second barrier member 126 opposes and is attached to the bottom surface 146 of the foam member 128. As shown, the foam member 128 shape generally corresponds to the shape of the first barrier element 124 and the second barrier element 126. Accordingly, the foam member 128 may be formed to extend within the one or more ribs 118, the corresponding spine 120, and the plurality of grooves 100.

Referring to FIG. 4, the layered configuration of the plate structure 100 may be a result of a simultaneous extrusion process 400. As shown, the simultaneous extrusion process 400 may include a plurality of hoppers 402a-402c that contain raw materials of each of the first barrier member 124, the second barrier member 126, and the foam member 128. Each material may be extruded through a corresponding extruder 404a-404c and enter a manifold 406 fit to a die 408. The die 408 subjects the extruded material to sufficient heat and/or pressure to fuse the first barrier member 124, the second barrier member 126, and the foam member 128 together as the materials exit the die 408. Further, a cooling roll 410 receives the output material and cools the material to produce the layered configuration of the plate structure 100. In these implementations, additional layers such as adhesive are unnecessary to create the layered configuration, as the heat and/or pressure created by the simultaneous extrusion process 400 fuses the materials together.

In some examples, a chemical reaction to produce gas is activated in the foam member 128 extruder 404b as a result of a temperature reaching a threshold. In these examples, the pressure within the manifold 406 and die 408 is higher than atmospheric, thereby compressing any activated gas within the manifold 406. The gas expands as the foam member 128 material exits the die 408. In other examples, a physical foaming agent such as gas (i.e., nitrogen gas) is introduced into the hopper 404b of the extruder 404b, and is kept under pressure while within the die 408. This creates a significant pressure differential that acts on the gas as it exits the die 408 to expand as it enters atmospheric pressure.

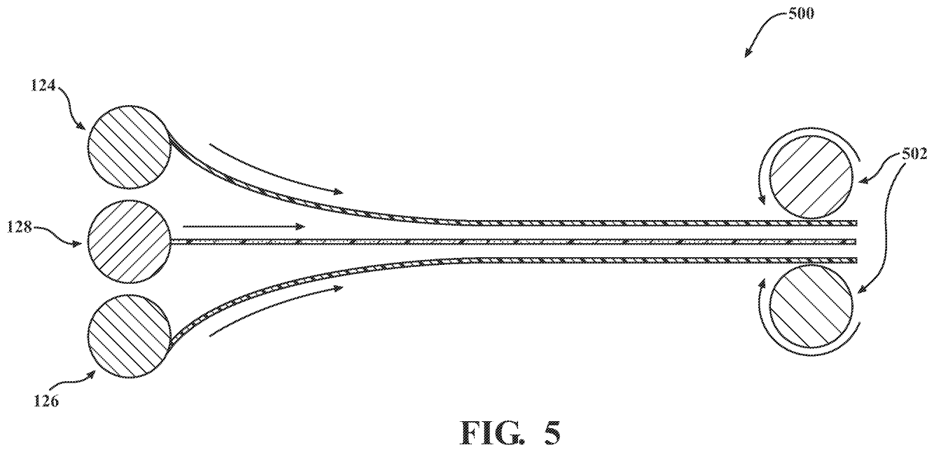

Alternatively, the layered configuration of the plate structure 100 may be the result of a calendering process 500. As shown in FIG. 5, each of the materials that form the first barrier member 124, the second barrier member 126, and the foam member 128 are separately extruded and cooled. The materials may then be processed through rolls 502 using heat and/or pressure to fuse the first barrier member 124, the second barrier member 126, and the foam member 128 together to form the layered configuration of the plate structure 100.

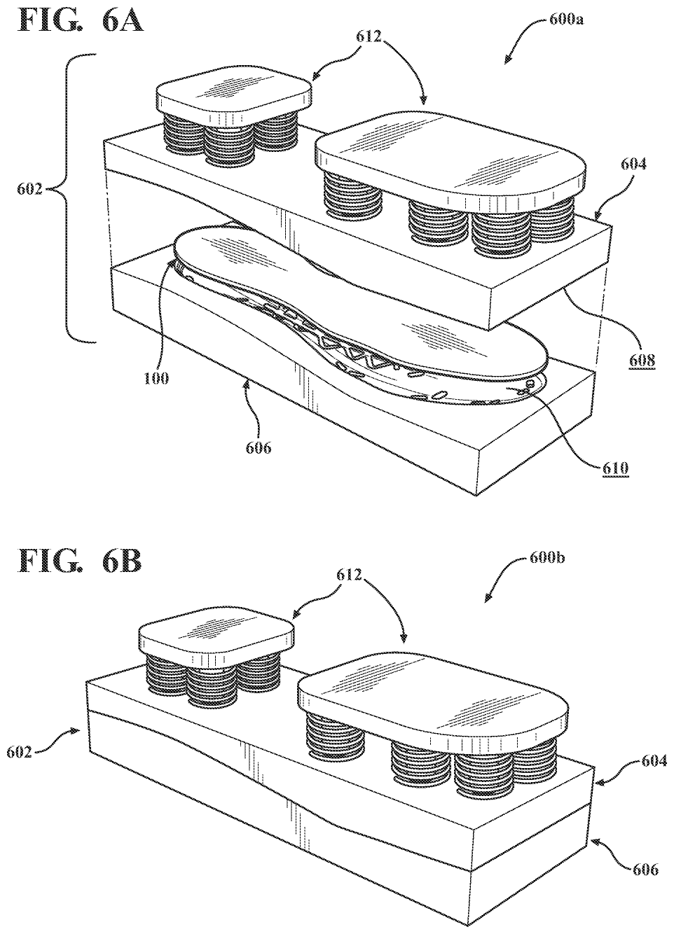

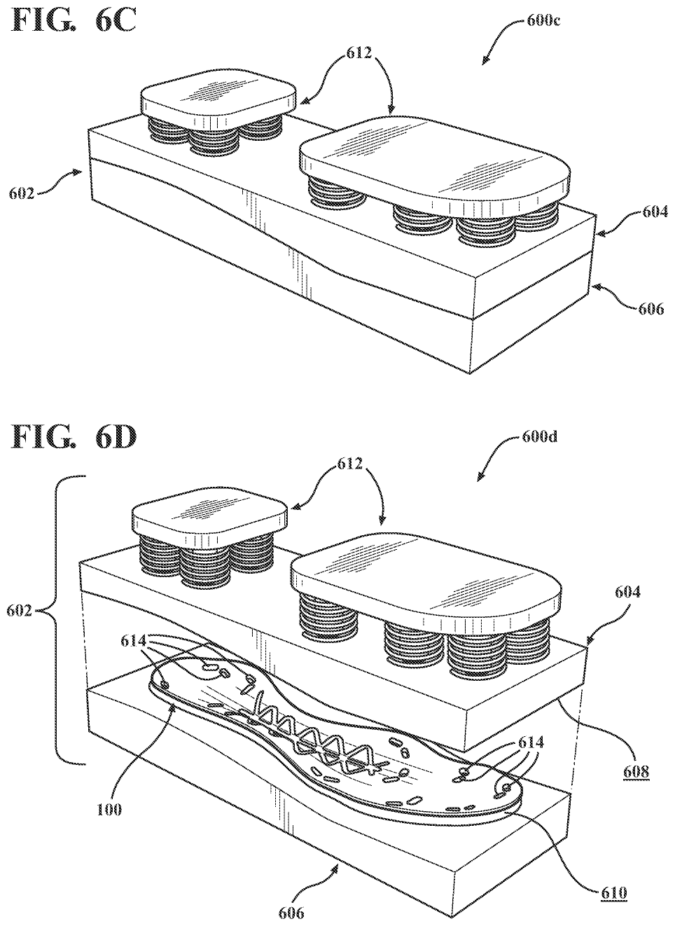

Referring to FIGS. 6A-6D, after the layered configuration of the plate structure 100 is formed, the plate structure 100 may be shaped using a plate structure forming process 600. The plate structure forming process 600 may use a press 602 including an upper platen 604 having a contoured inside surface 608, and a lower platen 606 having a contoured inside surface 610. The upper platen 604 may be reciprocally movable relative to the lower platen 606 to operate the press 602 between an open position (e.g., FIG. 6A), when the upper platen 604 is the furthest away from the lower platen 606, and a closed position (e.g., FIG. 6B), when the upper platen 604 is vertically aligned with, and proximate to, the lower platen 606 such that the inside surfaces 608, 610 are opposing, and in some instances, contacting one another. In some implementations, while in the closed position, the press 602 may further include a punching system 612 that operates to form a plurality of apertures 614 through the thickness T₁₀₀ of the plate structure 100 when in a punching position (FIG. 6C).

FIG. 6A shows step 600a, with the layered configuration of the plate structure 100 in a flat form, and the upper platen 604 of the press 602 in the open position. At step 600b, the upper platen 604 is lowered to meet with the lower platen 606 of the press 606 in the closed position (FIG. 6B). While in the closed position, the inside surfaces 608, 610 of the press apply pressure to shape the flat form of the plate structure 100 into a formed structure. In some implementations (FIG. 6C), the punching system 612 is moved to the punching position to form a plurality of apertures 614 at step 600d. During step 600d (FIG. 6D), the formed structure of the plate structure 100 may exit the press 602 for further processing including an injection process 700. In some implementations, the formed structure of the plate structure 100 is incorporated into a chassis that is attached to an upper.

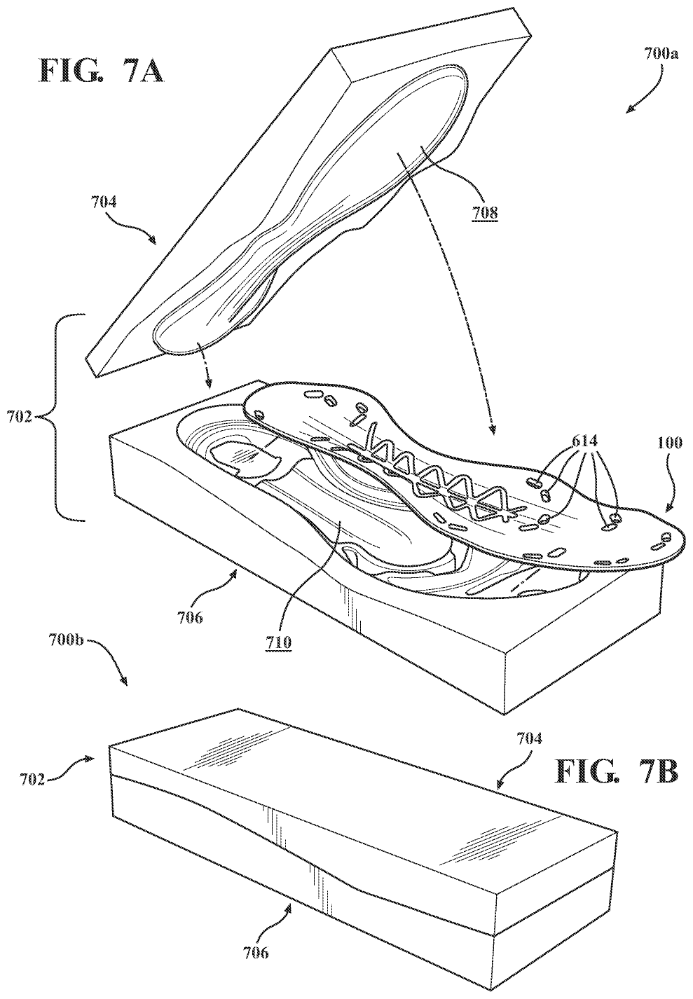

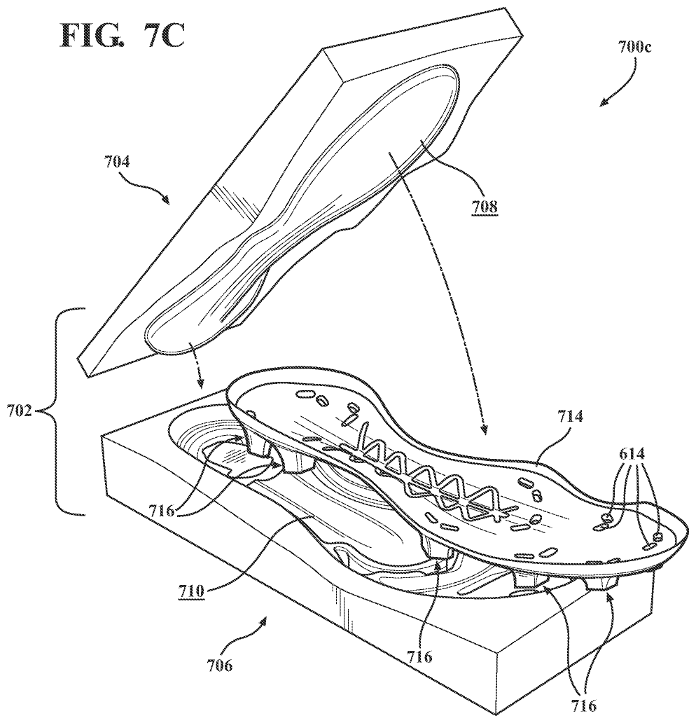

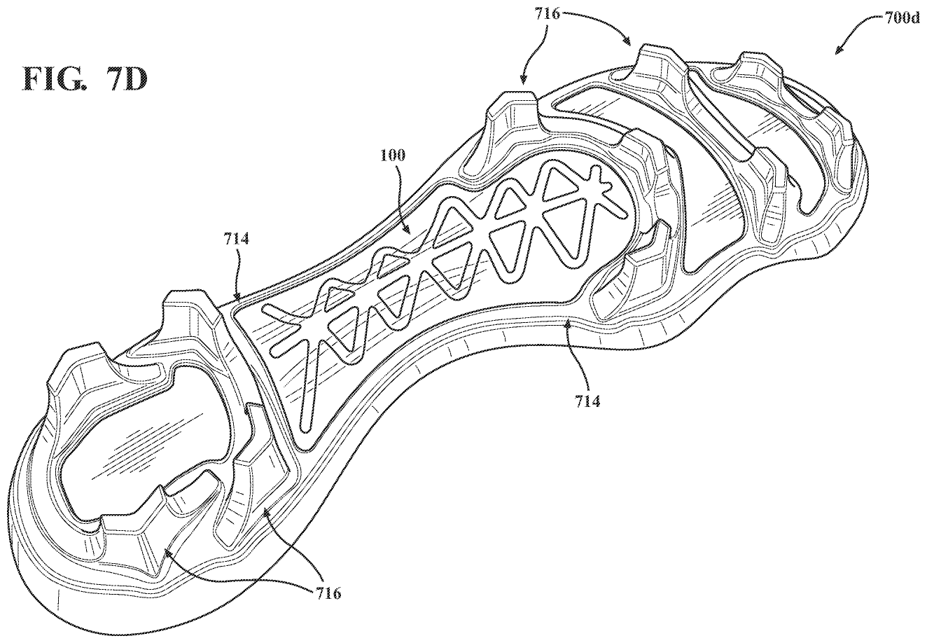

Referring to FIGS. 7A-7D, the formed structure of the plate structure 100 may serve as a base for directly attaching traction elements 716 of a cleat structure 714. The injection process 700 may use a mold 702 including an upper plate 704 and a lower plate 706. The upper plate 704 may be rotatably movable relative to the lower plate 706 to operate the mold between an open position (e.g., FIG. 7A) when the upper plate 704 is rotated away from the lower plate 706 to a closed position (e.g., FIG. 7B) when the upper plate 704 is in direct contact with the lower plate 706. While in the closed position, an inside surface 708 of the upper plate 704 and an inside surface 710 of the upper plate 706 may oppose one another and form a cavity 712 for injection molding.

FIG. 7A shows step 700a, with the formed structure of the plate structure 100 between the upper plate 704 and the lower plate 706 in the open position. At step 700b, the upper plate 704 is rotated toward the lower plate 706 in the closed position. The cleat structure 714 including a plurality of traction elements 716 is then injection molded onto the plate structure 100. In some examples, the traction elements 716 of the cleat structure are directly molded onto the plate structure 100 through the plurality of apertures 614 formed by the punching system 612 (FIG. 7D). At step 700c, the upper plate 704 is rotated back to the open position and the plate structure 100 including the cleat structure 714 may exit the mold 702. As shown at step 700d in FIG. 7D, the cleat structure 714 may define a profile of the ground-engaging surface and may at least partially cover the plate structure 100.

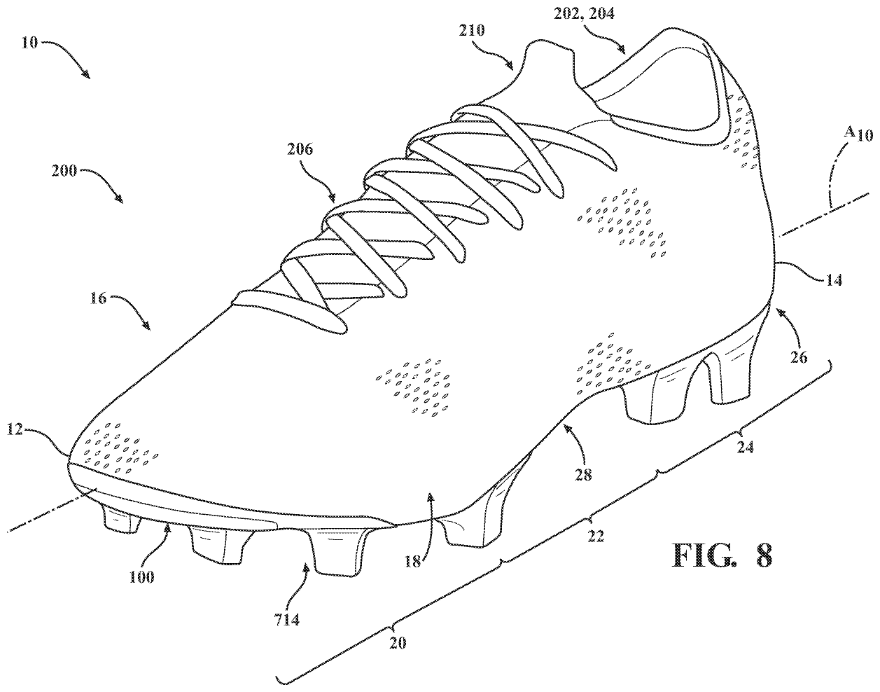

Referring to FIG. 8, an article of footwear 10 includes the plate structure 100, a cleat structure 714, and an upper 200 attached to the sole structure 100. The footwear 10 may further include an anterior end 12 associated with a forward-most point of the footwear 10, and a posterior end 14 corresponding to a rearward-most point of the footwear 10. A longitudinal axis A₁₀ of the footwear 10 extends along a length of the footwear 10 from the anterior end 12 to the posterior end 14 parallel to a ground surface, and generally divides the footwear 10 into a medial side 16 and a lateral side 18. Accordingly, the medial side 16 and the lateral side 18 respectively correspond with opposite sides of the footwear 10 and extend from the anterior end 12 to the posterior end 14. As used herein, a longitudinal direction refers to the direction extending from the anterior end 12 to the posterior end 14, while a lateral direction refers to the direction transverse to the longitudinal direction and extending from the medial side 16 to the lateral side 18.

The article of footwear 10 may be divided into one or more regions. The regions may include a forefoot region 20, a mid-foot region 22, and a heel region 24. The forefoot region 20 may correspond with the phalanges and the metatarsal bones of a foot. The mid-foot region 22 may correspond with an arch area of the foot, and the heel region 24 may correspond with rear portions of the foot, including a calcaneus bone.

The article of footwear 10 may be further described as including a peripheral region 26 and an interior region 28, as indicated in FIG. 1. The peripheral region 26 is generally described as being a region between the interior region 28 and an outer perimeter of the sole structure 100. Particularly, the peripheral region 26 extends from the forefoot region 20 to the heel region 24 along each of the medial side 16 and the lateral side 18, and wraps around each of the forefoot region 20 and the heel region 24. The interior region 28 is circumscribed by the peripheral region 26, and extends from the forefoot region 20 to the heel region 24 along a central portion of the sole structure 100. Accordingly, each of the forefoot region 20, the mid-foot region 22, and the heel region 24 may be described as including the peripheral region 26 and the interior region 28.

As discussed above, the plate structure 100 may be incorporated into a chassis or be directly attached to the cleat structure 714 of an article of footwear 10. The upper 200 forms an enclosure having plurality of components that cooperate to define an interior void 202 and an ankle opening 204 in the heel region 24, which cooperate to receive and secure a foot for support on the plate structure 100. In some examples, one or more fasteners 206 extend along the upper 200 to adjust a fit of the interior void 202 around the foot while concurrently accommodating entry and removal of the foot therefrom. The upper 200 may include apertures such as eyelets and/or other engagement features such as fabric or mesh loops that receive the fasteners 206. The fasteners 206 may include laces, straps, cords, hook-and-loop, or any other suitable type of fastener. The upper 200 may include a tongue portion 210 that extends between the interior void 202 and the fasteners 206.

The upper 200 may be formed from one or more materials that are stitched or adhesively bonded together to define the interior void 202. Suitable materials of the upper 200 may include, but are not limited to, textiles, foam, leather, and synthetic leather. The example upper 200 may be formed from a combination of one or more substantially inelastic or non-stretchable materials and one or more substantially elastic or stretchable materials disposed in different regions of the upper 200 to facilitate movement of the article of footwear 10 between the tightened state and the loosened state. The one or more elastic materials may include any combination of one or more elastic fabrics such as, without limitation, spandex, elastane, rubber or neoprene. The one or more inelastic materials may include any combination of one or more of thermoplastic polyurethanes, nylon, leather, vinyl, or another material/fabric that does not impart properties of elasticity.

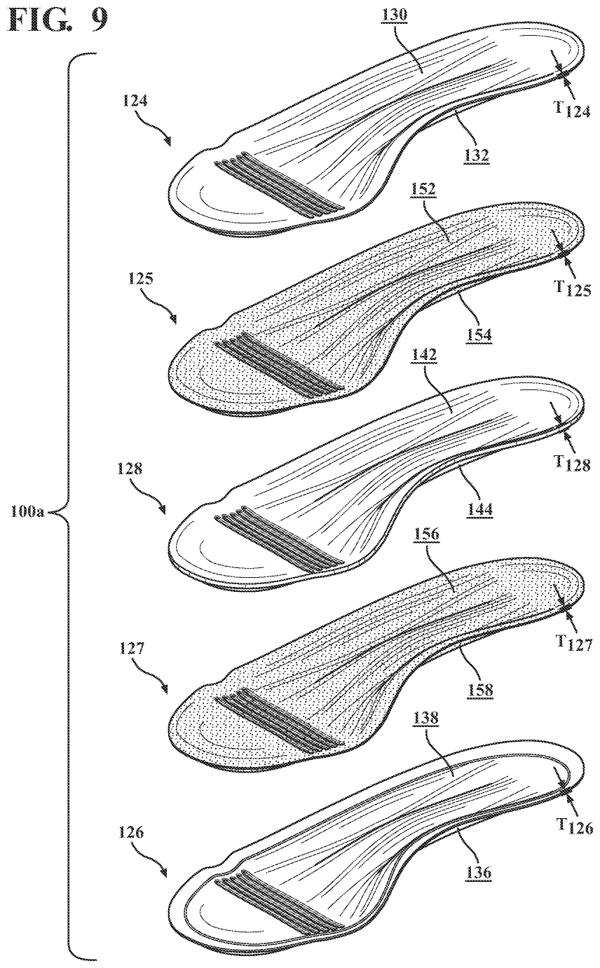

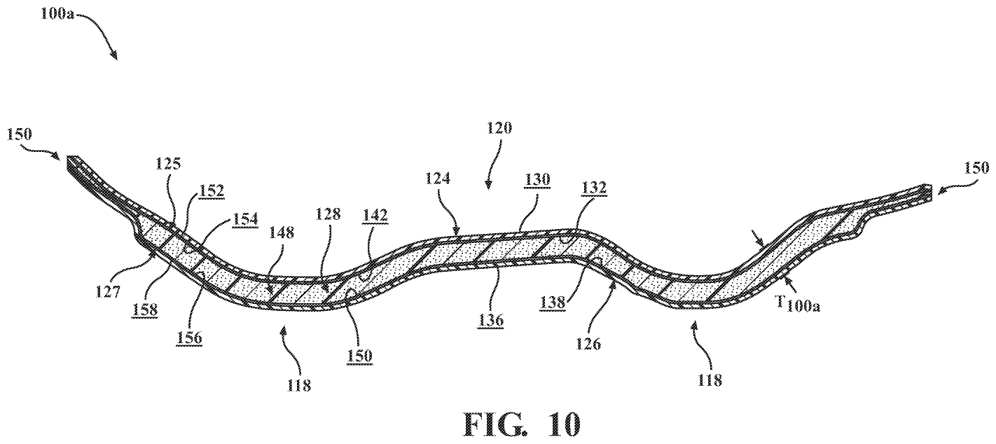

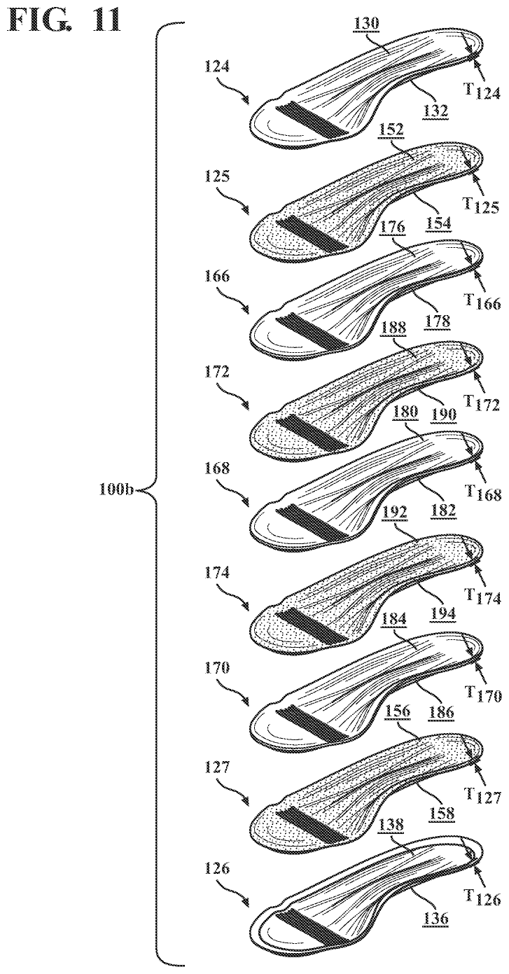

With particular reference to FIGS. 9 and 10, a plate structure 100a is provided. In view of the substantial similarity in structure and function of the components associated with the plate structure 100 with respect to the plate structure 100a, like reference numerals are used hereinafter and in the drawings to identify like components while like reference numerals containing letter extensions are used to identify those components that have been modified.

Referring to FIGS. 9 and 10, the plate structure 100a includes a first barrier member 124, a second barrier member 126 formed on opposite side of the plate structure 100a than the first barrier member 124, and a foam member 128 disposed between the first barrier member 124 and the second barrier member 126. The plate structure 100a further includes a first adhesive layer 125 disposed between the bottom surface 132 of the first barrier member 124 and the top surface 142 of the foam member 128, and a second adhesive layer 127 disposed between the bottom surface 144 of the foam member 128 and the top surface 138 of the second barrier member 126. As such, the first barrier member 124, the second barrier member 126, the foam member 128, the first adhesive layer 125, and the second adhesive layer 127 are arranged in a layered configuration.

The first adhesive layer 125 may further be defined by a top surface 152 and a bottom surface 154 formed on an opposite side of the first adhesive layer 125 than the top surface 152. A thickness T₁₂₅ of the first adhesive layer 125 is defined by a distance between the top surface 152 and the bottom surface 154. The second adhesive layer 127 may further be defined by a top surface 156 and a bottom surface 158 formed on an opposite side of the second adhesive layer 127 than the top surface 156. A thickness T₁₂₇ of the second adhesive layer 127 is defined by a distance between the top surface 156 and the bottom surface 158.

The adhesive layers 125, 127 may be a hot meld adhesive, a cement, or the like. Accordingly, the adhesive layers 125, 127 operate to adhesively bond together the first barrier member 124, the second barrier member 126, and the foam member 128 to form the plate structure 100a. Like the thicknesses T₁₂₄, T₁₂₆ of the first barrier member 124 and the second barrier member 126, the thicknesses T₁₂₅, T₁₂₇ of the adhesive layers 125, 127 may be the same. Alternatively, one of the thicknesses T₁₂₅, T₁₂₇ of the adhesive layers 125, 127 may be different than the other of the adhesive layers 125, 127.

As shown in FIG. 10, the plate structure 100a includes the first barrier member 124 attached to the second barrier member 126 and joined together at a peripheral edge 150 to define an interior void 148. The foam member 128 is disposed within and completely fills the interior void 148. As discussed with respect to FIG. 9, the first barrier member 124, the second barrier member 126, and the foam member 128 are arranged in a layered configuration. Accordingly, the bottom surface 132 of the first barrier member 124 opposes and is attached to the top surface 152 of the first adhesive layer 125. The bottom surface 154 of the first adhesive layer opposes and is attached to the top surface 142 of the foam member 128. Likewise, the top surface 138 of the second barrier member 126 opposes and is attached to the bottom surface 158 of the second adhesive layer 127. The top surface 156 of the second adhesive layer 127 opposes and is attached to the bottom surface 146 of the foam member 128. As shown, the foam member 128 shape generally corresponds to the shape of the first barrier element 124 and the second barrier element 126.

The plate structure 100a may further defined by thickness T₁₀₀ₐ extending between the top surface 130 of the first barrier member 124 and the bottom surface 136 of the second barrier member 126. In other words, the respective thicknesses T₁₂₄, T₁₂₅, T₁₂₈, T₁₂₇, and T₁₂₆ of the barrier member 124, the first adhesive layer 125, the foam member 128, the second adhesive layer 127, and the second barrier member 126 may further define the thickness T₁₀₀ₐ. In some implementations, the thicknesses T₁₂₅, T₁₂₇ of the adhesive layers is compressed into the foam member 128, resulting in a thickness T₁₀₀ₐ of the plate structure 100a that is substantially similar to the thickness T₁₀₀ of the plate structure 100. In other implementations, the adhesive layers 125, 127 may have a thickness that results in a thickness T₁₀₀ₐ of the plate structure 100a that is greater than the thickness T₁₀₀ of the plate structure 100.

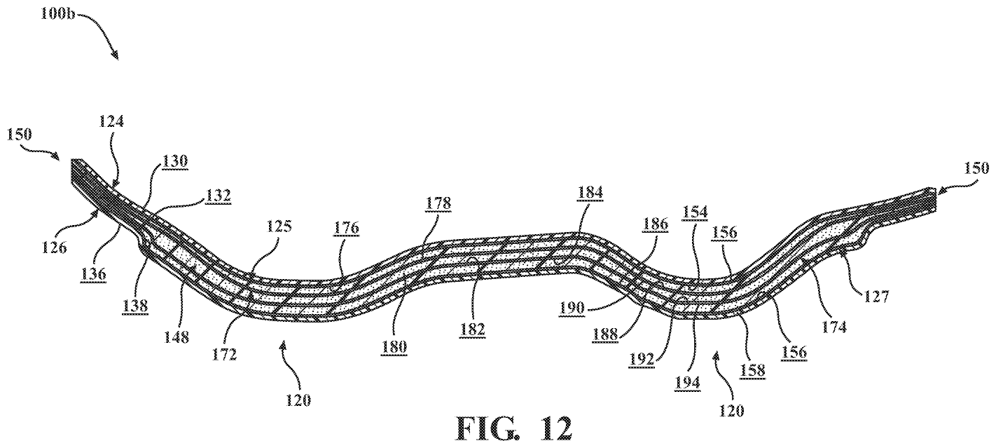

With particular reference to FIGS. 11 and 12, a plate structure 100b is provided. In view of the substantial similarity in structure and function of the components associated with the plate structures 100, 100a, with respect to the plate structure 100b, like reference numerals are used hereinafter and in the drawings to identify like components while like reference numerals containing letter extensions are used to identify those components that have been modified.

Referring to FIGS. 9 and 10, the plate structure 100b includes additional foam members to reinforce the plate structure 100b. For example, the plate structure 100b includes a first barrier member 124, a second barrier member 126 formed on opposite side of the plate structure 100a than the first barrier member 124, and a first foam member 166, a second foam member 168, a third foam member, a first adhesive layer 125, a second adhesive layer 127, a third adhesive layer 172, and a fourth adhesive layer 174 disposed between the first barrier member 124 and the second barrier member 126.

The first foam member 166 may further be defined by a top surface 176 and a bottom surface 178 formed on an opposite side of the first foam member 166 than the top surface 176. A thickness T₁₆₆ of the first foam member 166 is defined by a distance between the top surface 156 and the bottom surface 178. The second foam member 168 may be defined by a top surface 180 and a bottom surface 182 formed on an opposite side of the second foam member 168 than the top surface 180. A thickness T₁₆₈ of the second foam member 168 is defined by a distance between the top surface 180 and the bottom surface 182. The third foam member 170 may be defined by a top surface 184 and a bottom surface 186 formed on an opposite side of the third foam member 170 than the top surface 184. A thickness T₁₇₀ of the third foam member 170 is defined by a distance between the top surface 184 and the bottom surface 186.

The third adhesive layer 172 may further be defined by a top surface 188 and a bottom surface 190 formed on an opposite side of the third adhesive layer 172 than the top surface 188. A thickness T₁₇₂ of the third adhesive layer 172 is defined by a distance between the top surface 188 and the bottom surface 190. The fourth adhesive layer 174 may further be defined by a top surface 192 and a bottom surface 194 formed on an opposite side of the fourth adhesive layer 174 than the top surface 192. A thickness T₁₇₄ of the fourth adhesive layer 174 is defined by a distance between the top surface 192 and the bottom surface 194.

The plate structure 100b further includes the first barrier member 124 disposed on the first adhesive layer 125, the first adhesive layer 125 disposed on the first foam member 166, the first foam member 166 disposed on the third adhesive layer 172, the third adhesive layer 172 disposed on the second foam member 168, the second foam member 168 disposed on the fourth adhesive layer 174, the fourth adhesive layer 174 disposed on the third foam member 170, the third foam member 170 disposed on the second adhesive layer 127, and the second adhesive layer 127 disposed on the second barrier member 126. As such, the first barrier member 124, the first adhesive layer 125, the first foam member 166, the third adhesive layer 172, the second foam member 168, the fourth adhesive layer 174, the third foam member 170, the second adhesive layer 127, and the second barrier member 126 are arranged in a layered configuration.

Like the adhesive layers 125, 127, the adhesive layers 172, 174 may be a hot meld adhesive, a cement, or the like. Accordingly, the adhesive layers 125, 127, 172, 174 operate to adhesively bond together the first barrier member 124, the first foam member 166, the second foam member 168, the third foam member 170, and the second barrier member 126 to form the plate structure 100b. Like the thicknesses T₁₂₅, T₁₂₇ of the adhesive layers 125, 127, the thicknesses T₁₇₂, T₁₇₄ of the adhesive layers 172, 174 may be the same. Alternatively one of the thicknesses T₁₂₅, T₁₂₇, T₁₇₂, T₁₇₄ of the adhesive layers 125, 127, 172, 174 may be different than the other of the adhesive layers 125, 127, 172, 174.

As shown in FIG. 12, the plate structure 100b includes the first barrier member 124 attached to the second barrier member 126 and joined together at a peripheral edge 150 to define an interior void 148. The first foam member 166, the second foam member 168, and the third foam member 170 are disposed within and completely fill the interior void 148. As discussed with respect to FIG. 11, the first barrier member 124, the first adhesive layer 125, the first foam member 166, the third adhesive layer 172, the second foam member 168, the fourth adhesive layer 174, the third foam member 170, the second adhesive layer 127, and the second barrier member 126 are arranged in a layered configuration. Accordingly, the first adhesive layer 125 is disposed between and attaches the bottom surface 132 of the first barrier member 124 to the top surface 176 of the first foam member 166, while the third adhesive layer 172 is disposed between and attaches the bottom surface 176 of the first foam member 166 to the top surface 180 of the second foam member 168. Likewise, the fourth adhesive layer 174 is disposed between and attaches the bottom surface 182 of the second foam member 168 and the top surface 184 of the third foam member 170, while the second adhesive layer 127 is disposed between and attaches the bottom surface 186 of the third foam member 170 to the top surface 138 of the second barrier member 126. As shown, a shape of the foam members 166, 168, 170 generally corresponds to the shape of the first barrier element 124 and the second barrier element 126.

The plate structure 100b may further defined by thickness T_{100b} extending between the top surface 130 of the first barrier member 124 and the bottom surface 136 of the second barrier member 126. In other words, the respective thicknesses T₁₂₄, T₁₂₅, T₁₆₆, T₁₇₂, T₁₆₈, T₁₇₄, T₁₇₀, T₁₂₇, and T₁₂₆ of the first barrier member 124, the first adhesive layer 125, the first foam member 166, the third adhesive layer 172, the second foam member 168, the fourth adhesive layer 174, the third foam member 170, the second adhesive layer 127, and the second barrier member 126 may further define the thickness T_{100b}. In some implementations, the thicknesses T₁₂₅, T₁₂₇, T₁₇₂, T₁₇₄, of the adhesive layers is compressed into the foam members 166, 168, 170, resulting in a thickness T_{100b} of the plate structure 100a that is substantially similar to a thickness of barrier members 124, 126 and the foam members 166, 168, 170. Because the plate structure 100b includes more than one foam member 166, 168, 170, the thickness T_{100b} of the plate structure 100b is greater than the thicknesses T₁₀₀, T₁₀₀ₐ of the plate structures 100, 100a.

While FIG. 11 shows the foam members 166, 168, 170 formed with the same thickness, in some implementations, at least one of the foam members 166, 168, 170 is formed with a different thickness than the other of the foam members 166, 168, 170. For example, the second foam member 168, disposed in the center of the plate structure 100b, may include a greater thickness T₁₆₈ than that of the first foam member 166 and the third foam member 170 to operate as a reinforcing layer for the plate structure 100b.

The following Clauses provide an exemplary configuration for a sole structure for an article of footwear, an article of footwear, and a composite structure described above.

Clause 1. A plate for an article of footwear, the plate comprising: a first film member; a second film member attached to the first film member to define an interior void between the first film member and the second film member; and a foam member disposed within and completely filling the interior void.

Clause 2. The plate of Clause 1, wherein at least one of the first film member and the second film member is formed from thermoplastic polyurethane (TPU).

Clause 3. The plate of Clause 2, wherein the foam member is formed from TPU.

Clause 4. The plate of any of the preceding Clauses, wherein at least two of the first film member, the second film member, and the foam member are formed from the same material.

Clause 5. The plate of any of the preceding Clauses, wherein the first film member is attached to a first side of the foam member and the second film member is attached to a second side of the foam member, the second side being disposed on an opposite side of the foam member than the first side.

Clause 6. The plate of Clause 5, further comprising a first adhesive disposed between the first film member and the first side of the foam member and a second adhesive disposed between the second film member and the second side of the foam member.

Clause 7. The plate of Clause 6, wherein at least one of the first adhesive and the second adhesive is a hot melt adhesive.

Clause 8. The plate of any of the preceding Clauses, wherein at least one of the first film member and the second film member defines a rib.

Clause 9. The plate of Clause 8, wherein the foam member extends into the rib within the interior void.

Clause 10. A sole structure for an article of footwear incorporating the plate of any of the preceding Clauses.

Clause 11. A plate for an article of footwear, the plate comprising: a first film member; a second film member attached to the first film member to define an interior void between the first film member and the second film member; and a foam member disposed within the interior void and being formed from the same material as at least one of the first film member and the second film member.

Clause 12. The plate of Clause 11, wherein at least one of the first film member and the second film member is formed from thermoplastic polyurethane (TPU).

Clause 13. The plate of Clause 12, wherein the foam member is formed from TPU.

Clause 14. The plate of any of the preceding Clauses, wherein the first film member is attached to a first side of the foam member and the second film member is attached to a second side of the foam member, the second side being disposed on an opposite side of the foam member than the first side.

Clause 15. The plate of Clause 14, further comprising a first adhesive disposed between the first film member and the first side of the foam member and a second adhesive disposed between the second film member and the second side of the foam member.

Clause 16. The plate of Clause 15, wherein at least one of the first adhesive and the second adhesive is a hot melt adhesive.

Clause 17. The plate of any of the preceding Clauses, wherein at least one of the first film member and the second film member defines a rib.

Clause 18. The plate of Clause 17, wherein the foam member extends into the rib within the interior void.

Clause 19. A sole structure for an article of footwear incorporating the plate of any of the preceding Clauses.

Clause 20. An article of footwear incorporating the plate of any of the preceding Clauses.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A plate for an article of footwear, the plate comprising:
a first film member;
a second film member attached to the first film member to define an interior void between the first film member and the second film member; and
a foam member disposed within and completely filling the interior void.

2. The plate of claim 1, wherein at least one of the first film member and the second film member is formed from thermoplastic polyurethane (TPU).

3. The plate of claim 2, wherein the foam member is formed from TPU.

4. The plate of claim 1, wherein at least two of the first film member, the second film member, and the foam member are formed from the same material.

5. The plate of claim 1, wherein the first film member is attached to a first side of the foam member and the second film member is attached to a second side of the foam member, the second side being disposed on an opposite side of the foam member than the first side.

6. The plate of claim 5, further comprising a first adhesive disposed between the first film member and the first side of the foam member and a second adhesive disposed between the second film member and the second side of the foam member.

7. The plate of claim 6, wherein at least one of the first adhesive and the second adhesive is a hot melt adhesive.

8. The plate of claim 1, wherein at least one of the first film member and the second film member defines a rib.

9. The plate of claim 8, wherein the foam member extends into the rib within the interior void.

10. A sole structure for an article of footwear incorporating the plate of claim 1.

11. A plate for an article of footwear, the plate comprising:
a first film member;
a second film member attached to the first film member to define an interior void between the first film member and the second film member; and
a foam member disposed within the interior void and being formed from the same material as at least one of the first film member and the second film member.

12. The plate of claim 11, wherein at least one of the first film member and the second film member is formed from thermoplastic polyurethane (TPU).

13. The plate of claim 12, wherein the foam member is formed from TPU.

14. The plate of claim 11, wherein the first film member is attached to a first side of the foam member and the second film member is attached to a second side of the foam member, the second side being disposed on an opposite side of the foam member than the first side.

15. The plate of claim 14, further comprising a first adhesive disposed between the first film member and the first side of the foam member and a second adhesive disposed between the second film member and the second side of the foam member.

16. The plate of claim 15, wherein at least one of the first adhesive and the second adhesive is a hot melt adhesive.

17. The plate of claim 11, wherein at least one of the first film member and the second film member defines a rib.

18. The plate of claim 17, wherein the foam member extends into the rib within the interior void.

19. A sole structure for an article of footwear incorporating the plate of claim 11.

20. An article of footwear incorporating the plate of claim 11.
